(19) United States
(12) Patent Application Publication
(10) Pub. No.: US 2025/0178178 A1
(43) Pub. Date: Jun. 5, 2025

(54) Power Tool System with a Detachable Level

(71) Applicant: Robert Bosch GmbH, Stuttgart (DE)

(72) Inventor: Gregory A. Herman, Elk Grove Village, IL (US)

(21) Appl. No.: 18/525,320

(22) Filed: Nov. 30, 2023

(51) Int. Cl. B25F 5/02; H02J 50/10

(52) U.S. Cl. CPC B25F 5/022; B25F 5/029; H02J 50/10

(57) ABSTRACT

A power tool system includes a power tool having a receptacle, and a detachable level configured to be detachably received in the receptacle. The detachable level includes a leveling device.

### FIELD

This disclosure relates generally to power tool systems, and, more particularly, to a power tool system with a detachable level.

### BACKGROUND

Power tools are frequently used to drill, cut, and otherwise perform machining operations. Often, a user desires to cut a level line, or drill holes or insert fasteners along a level line. Typically, a spirit level is used to aid the user in marking a level line, and the machining is then performed along this line.

However, a spirit level is typically relatively short, which limits the length and accuracy of the level line marked by the user. One known solution is to use a laser level to make the level line on the surface to be machined. Laser levels, however, are usually relatively large and expensive. Moreover, the laser level must be mounted in a suitable location to project the laser line on the surface. Further, since a laser level is an additional component, it requires additional space in the user's toolbox and requires a user to keep track of another tool.

It would thus be desirable to provide a leveling device that is small and easily mountable to a surface, and that can be stored with an associated power tool.

### SUMMARY

In one embodiment, a power tool system includes a power tool having a receptacle, and a detachable level configured to be detachably received in the receptacle. The detachable level includes a leveling device.

In another embodiment, a power tool system comprises a power tool having a receptacle, and a detachable level configured to be detachably received in the receptacle, The detachable level includes a self-leveling laser line generator configured to generate at least one level laser line, and at least one power source that is operably connected to the laser line generator and is configured to receive electrical energy from the power tool.

In yet another embodiment according to the disclosure, a laser level configured to be detachable received in a receptacle of a power tool, comprises a housing defining at least one window; at least one laser line generator configured to emit at least one laser line through the at least one window of the housing; a power source configured to supply electrical power to the at least one laser line generator; a switch configured to automatically activate the at least one laser generator when the detachable level is removed from the receptacle and automatically deactivate the at least one laser generator when the detachable level is inserted into the receptacle; and a pendulum unit on which the at least one laser line generator, the power source, and the housing are arranged, the pendulum unit being pivotably arranged in the housing in such a way that the at least one laser line generator is self-leveling.

### BRIEF DESCRIPTION OF THE DRAWINGS

FIG. 1 is a schematic illustration of a power tool having a detachable level according to the disclosure.

FIG. 2 is a front view of the lower portion of the power tool of FIG. 1 showing the receptacle for the detachable level.

FIG. 3 is a top cutaway view of the detachable level for the power tool of FIG. 1 with a portion of the housing removed to show the interior features of the detachable level.

FIG. 4 is a bottom-left perspective view of the detachable level of FIG. 3.

FIG. 5 is a top-right perspective view of the detachable level of FIG. 3.

FIG. 6 is a schematic perspective view of another embodiment of a detachable level for the power tool of FIG. 1.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

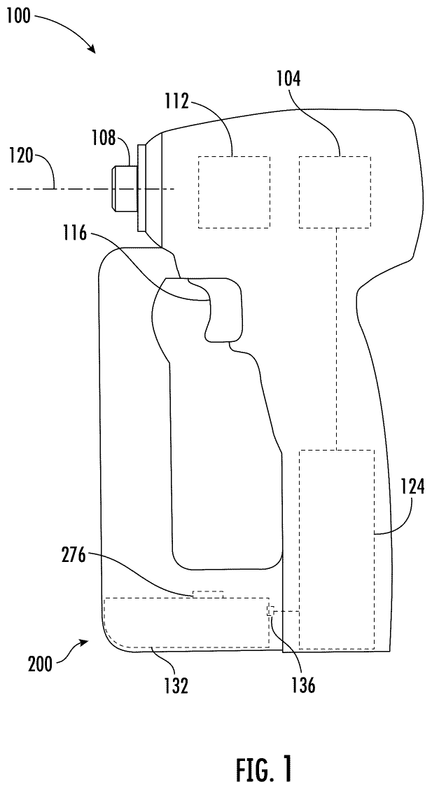

FIG. 1 illustrates a power tool 100 having a detachable level 200. The power tool 100 may be any suitable power tool, and is in particular a machining power tool configured to remove material from a workpiece by machining the workpiece. The power tool 100 may be, for example, a rotary tool (e.g., a hammer drill, drill driver, power drill, impact wrench, power screwdriver, etc.), a cutting tool (e.g., a jigsaw, reciprocating saw, oscillating saw, circular saw, angle grinder, etc.), or another suitable tool. In one embodiment, the power tool 100 is a portable battery-powered machining power tool, shown in the illustrated embodiment as a power drill.

The power tool 100 includes an electric motor 104 operably connected to a bit holder 108 by, for example, a transmission arrangement 112 such that, when activated by a switch such as trigger switch 116, the electric motor 104 drives the bit holder 108 to rotate about an output axis 120. The bit holder 108 receives a tool bit (not shown) such that the rotational motion of the bit holder 108 drives the tool bit to rotate about the output axis 120 to perform, for example, a drilling or screwdriving operation. The electric motor 104 is operably connected to a power source, which may be, for example, a removable rechargeable battery 124, a fixed rechargeable battery configured to be recharged via a corded connection, e.g., a USB cable, or a power cord. The power source provides electrical energy to operate the electric motor 104.

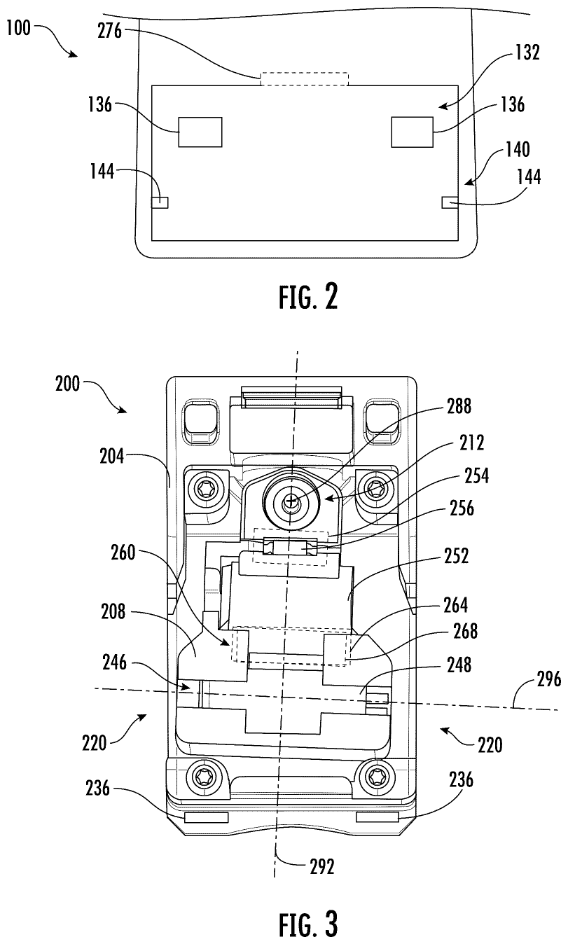

The power tool 100 also includes a receptacle 132, best seen in FIG. 2, that receives the detachable level 200. A plurality of electrical contacts 136, which are operably connected to the battery 124, are arranged in the receptacle 132 so as to transfer power to the detachable level 200. In some embodiments, instead of electrical contacts, the power tool 100 may instead include an inductive loop, RF charging coil, a cord or plug for a power cord, or other suitable charging arrangement.

In addition, the power tool 100 includes a locking arrangement 140 that locks the detachable level 200 in the receptacle 132. The locking arrangement 140 may include, for example, locking members 144. The locking members 144 may be configured to retain the detachable level 200 with sufficient force that disables the detachable level 200 from inadvertently falling out of the receptacle 132, but allows the detachable level 200 to be removed by being pulled out by the user. Alternatively, the locking members 144 may be configured to positively lock the detachable level 200 in the receptacle 132, and be actuated by a button, lever, or slide switch to release the detachable level 200 to enable the detachable level to be removed from the power tool 100.

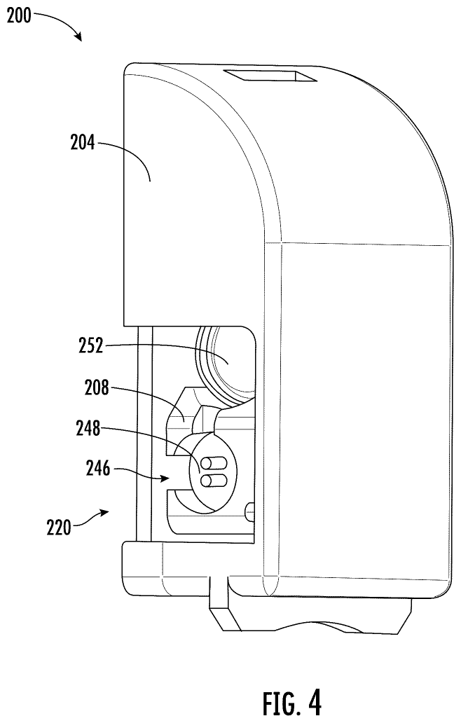

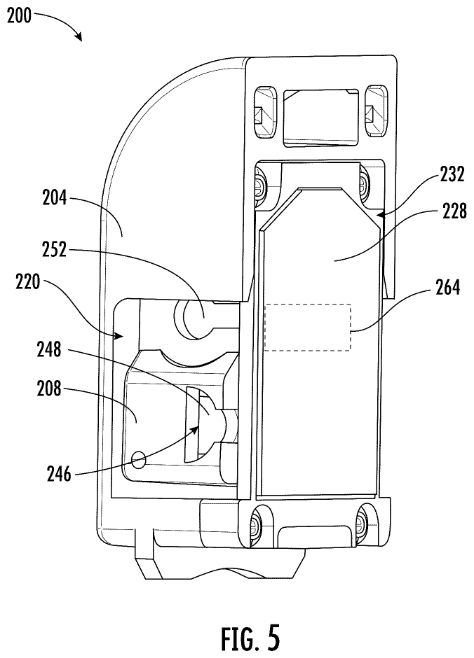

Referring now to FIGS. 3-5, the detachable level 200 includes a housing 204 and a pendulum unit 208 mounted in the housing 204 by a bearing 212. A respective window 220 is defined in the housing 204 on each lateral side thereof. The detachable level 200 is configured, in some embodiments, to interact with the locking members 144 of the power tool 100 such that the locking members 144 engage the surface of the housing 204 that defines the windows 220 to lock the detachable level 200 in the receptacle 132.

In addition, the detachable level 200 includes a mounting arrangement 228 arranged in or on the housing 204 and configured to enable the detachable level 200 to be attached to a desired surface. In the illustrated embodiment, the mounting arrangement 228 is an adhesive pad mounted in a recess 232 of the housing 204. In other embodiments, the mounting arrangement 228 may include, for example, double sided tape, a micro-suction adhesive, tacky gel, one or more magnets, thumb tacks, or the like.

The housing 204 also includes a plurality of housing electrical contacts 236 arranged on an exterior surface of the housing 204. The housing electrical contacts 236 are configured to contact the electrical contacts 136 in the receptacle 132 when the detachable level 200 is installed in the receptacle 132 such that the housing 204 receives electrical energy from the battery 124 of the power tool 100.

The pendulum unit 208 supports a leveling device 246, which has at least one laser line generator 248, in addition to a power source 252, control electronics 254, and a switch 256. In the illustrated embodiment, the leveling device 246 comprises a single laser line generator configured to emit two laser lines, one line through each of the windows 220 in each lateral direction. In another embodiment, the at least one laser line generator 248 may include two distinct laser line generators, each of which emits a laser line through one of the two windows 220. In a further embodiment, the at least one laser line generator may include only one laser line generator configured to emit a single laser line in only one lateral direction. In addition, the reader should appreciate that the at least one laser line generator 248 may be configured in various embodiments to generate one or more of a horizontal laser line, a vertical laser line, and a laser line in another desired orientation.

The at least one laser line generator 248 is powered by the power source 252, which is also mounted on the pendulum unit 208. The power source 252 may be, for example, a rechargeable lithium-ion battery. The power source 252 is charged by a charging arrangement 260. In the illustrated embodiment, the charging arrangement 260 is a wireless charging arrangement, for example an inductive loop arrangement that includes an inductive loop 264 on the housing and a corresponding inductive loop 268 on the pendulum unit. interfaces with a corresponding inductive loop mounted on the interior of the housing 204 to wirelessly receive electrical energy from the housing. The inductive loop 264 of the housing 204 is electrically connected to the electrical contacts 236 of the housing 204 to receive the electrical power from the battery 124 via the electrical contacts 136, 236. The inductive loop 268 of the pendulum unit 208 is paired with the inductive loop 264 of the housing 204 such that the inductive loop 268 receives the electrical power from the battery 124 via the electrical contacts 136, 236 and the inductive loop 264 of the housing 204. In another embodiment, the charging arrangement may include one or more electrical contacts that directly electrically connect the pendulum unit 208 to the housing 204 such that the power source 232 receives electrical energy from the power tool 100 via the electrical contacts 136 of the power tool 100 and the corresponding contacts 236 on the housing 204.

The control electronics 254 include a charging circuit designed to monitor the state of charge of the power source 252 and to activate and deactivate the charging of the power source 252 depending on the state of charge. In addition, as discussed below, the control electronics 254 control the activation and deactivation of the at least one laser line generator 248.

Specifically, the switch 256 is designed to generate an electrical signal indicative of whether the detachable level 200 is present in the receptacle 132, or is removed from the receptacle 132. In response to the generated electrical signal, the control electronics 254 are configured to activate and deactivate the at least one laser line generator 248. In the illustrated embodiment, the switch 256 is a reed switch that interfaces with a corresponding magnet 276 (FIG. 1) mounted in the interior of the receptacle 132. The switch 256 is configured to generate a signal when in the presence of the magnet 276, indicating that the detachable level 200 is present in the receptacle 132, and the control electronics 254 deactivate the at least one laser line generator 248 in response to the signal indicating the presence of the magnet 276. Alternatively, when the switch 256 fails to detect the presence of the magnet 276, indicating that the detachable level 200 is not in the receptacle 132, the control electronics 254 are configured to activate the at least one laser line generator 248. In this way, the at least one laser line generator 248 is automatically activated when removed from the receptacle 132, and automatically deactivated when inserted back into the receptacle 132. In other embodiments, the switch 256 may instead be a mechanical switch actuated by a corresponding mechanical switching element (e.g. a post or wedge) in the receptacle, or an electrical switch actuated either by the electrical energy received through the charging arrangement 260 or by a corresponding electrical contact in the receptacle. In another embodiment, the switch 256 may be a manually actuated switch, for example a rocker, toggle, or sliding switch, a control knob, or a push button, activated by a user to activate and deactivate the at least one laser line generator 248.

As noted above, the pendulum unit 208 is mounted in the housing 204 by a bearing 212. In particular, the pendulum unit 208 is rotatable about a pivot axis 288 defined at the center of the bearing 212. The pendulum unit 208 is designed such that nearly all of its weight lies on one side of the pivot axis 288. Specifically, at least the laser line generator 248 and the power source 252 are located below the pivot axis 288 when the detachable level 200 is mounted in a generally upright orientation. In the illustrated embodiment, the control electronics 254 and the switch 256 are also on the same side of the pivot axis 288 as the laser line generator 248 and the power source 252. As a result, the pendulum unit 208 hangs from the bearing 212.

In addition, the weight of the pendulum unit 208 is evenly balanced about the plane 292 in which the pivot axis 288 is located and that runs perpendicular to the axis 296 of the at least one laser line generator 248 along which the laser line generator 248 projects a horizontal line. As a result, the pendulum unit 208 hangs in such a manner that the laser line generator 248 projects laser lines to each side of the detachable level 200 that are horizontally level even when the detachable level 200 is mounted at an angle to horizontal. In other words, the pendulum unit 208 is configured such that the detachable level is self-leveling.

Moreover, the pendulum unit 208 is designed to interact with the locking members 144 to reduce or disable relative movement of the pendulum unit 208. Specifically, when the detachable level 200 is installed in the receptacle 132, the locking members 144 extend through the windows 220 and engage the lateral sides of the pendulum unit 208. As a result, the pendulum unit 208 is largely fixed in place such that the pendulum unit 208 does not rotate about the pivot axis 288 and therefore does not swing within the receptacle 132. Consequently, the locking members 144 disable the pendulum unit 208 from being damaged by the sides of the receptacle 132 if the power tool 100 is moved, impacted, or dropped.

As noted above, the detachable level 200 is detachable from the power tool 100. In particular, as used herein, the term “detachable” means the detachable level 200 is designed to be removed from the power tool 100 without the use of tools, without damaging or destroying the functionality of either the power tool 100 or the detachable level 200, and in such a way that the detachable level 200 is usable when detached from the power tool 100. When the user desires to use the detachable level 200, the user simply grasps the detachable level 200 and slides it out from the receptacle 132 or, in some embodiments, releases the locking members 144 and detaches the detachable level 200 from the power tool 100.

When the detachable level 200 is removed from the power tool 100, the switch 256 is separated from the magnet 276. As a result, the switch 256 is activated, and in response the control electronics 254 activate the at least one laser line generator 248 to emit the laser lines along the laser generator axis 296. The user can then attach the detachable level 200 to the surface on which the leveling line is to be projected using the mounting arrangement 228. For example, the user may stick the detachable level 200 to a wall using the adhesive of the mounting arrangement 228.

Since the pendulum unit 208 of the detachable level 200 is balanced about the plane perpendicular to the laser generator axis 296, the pendulum unit 208 hangs from the bearing 212 so as to be self-leveling. Accordingly, the laser generator axis 296 generates a level laser line even if the detachable level 200 is not aligned with horizontal. Consequently, the detachable level 200 is simple to use since the user can position the detachable level 200 on the surface with substantial offset from horizontal and still obtain a horizontally level line. In one particular embodiment, for example, the detachable level 200 produces a horizontally level line even when the housing 204 of the detachable level 200 is misaligned on the surface by up to 15 degrees from vertical.

When the user has completed the machining processes utilizing the level laser line, the user removes the detachable level 200 from the surface by disengaging the mounting arrangement 228 from the surface. The detachable level 200 can then be reinserted into the receptacle 132. Once reinserted, the locking members 144 interface with the housing 204 of the detachable level 200 to lock the detachable level 200 in the power tool 100. The switch 256 detects the presence of the magnet 276, and in response the control electronics 254 deactivates the at least one laser line generator 248.

When the detachable level 200 is present in the receptacle, the electrical contacts 236 of the housing 204 electrically contact the electrical contacts 136 in the receptacle 236. As a result, the battery 124 of the power tool 100 transmits electrical energy via the contacts 136, 236 and the charging arrangement 260 to the power source 252 of the detachable level 200 to charge the power source 252 of the detachable level 200. The detachable level 200 is therefore charged by the battery 124 of the power tool 100 when it is inserted into the receptacle 124.

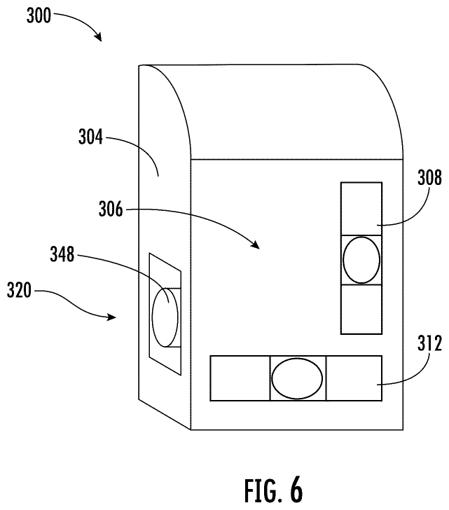

Another embodiment of a detachable level 300 is depicted in FIG. 6. The detachable level 300 is configured essentially the same as the embodiment of FIGS. 1-5, except the detachable level 300 does not include a pendulum unit. Specifically, the housing 304 of the detachable level 300 includes a vertically-oriented sprit or bubble level 308 and a horizontally-oriented sprit or bubble level 312, both of which are mounted to or visible from the exterior of the housing 304. In addition, the detachable level 300 includes a leveling device 346 comprising a laser line generator 348 that is powered by a power source (not shown) in a similar manner as in the embodiment of FIGS. 1-5 and that generates a laser line that projects through a window 320 of the housing 304. The detachable level 300 of FIG. 6 is received in the receptacle 128 of the power tool 100 in a similar manner as the detachable level 200 of FIGS. 3-5, and the power source thereof receives electrical energy via a charging arrangement and electrical contacts in a similar manner as described above with regard to the detachable level 200.

As noted above, in the detachable level 300, the leveling device 306, which includes the laser line generator 348, and the battery are not installed on a pendulum unit, and instead are fixedly connected to the housing 304. To use the detachable level 300, the user removes the detachable level from the receptacle 128 of the power tool 100. The detachable level 300 may be configured to automatically activate the laser line generator 348 in response to being removed from the receptacle 128 in a similar manner as described above, or the laser line generator 348 may be manually activated in a similar manner as described above.

The user then aligns the housing 304 on the surface on which the laser line is to be generates such that one of the two spirit or bubble levels 308, 312 indicate that the housing is positioned level on the surface. In particular, to project a horizontal line, the user aligns the horizontal spirit or bubble level 312 level, and to project a vertical line, the user rotates the housing 304 such that the vertical sprit or bubble level 308 is level. The detachable level 300 is attached to the surface using a mounting arrangement as described above, thereby enabling the detachable level to project a level laser line on the surface. When the laser line is no longer required, the user detaches the detachable level 300 from the surface, and inserts it back into the receptacle 128.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the disclosure.

1. A power tool system comprising:
a power tool having a receptacle; and
a detachable level configured to be detachably received in the receptacle, the detachable level including a leveling device.

2. The power tool system according to claim 1, the detachable level further comprising a housing in which the leveling device is arranged, the housing being configured to interact with the receptacle to retain the detachable level in the receptacle.

3. The power tool system according to claim 2, wherein the leveling device comprises at least one laser line generator configured to emit at least one laser line through a window of the housing.

4. The power tool system according to claim 3, wherein the detachable level further comprises a power source configured to supply electrical power to the at least one laser line generator.

5. The power tool system according to claim 4, wherein the power tool further comprises a battery operably connected to the power source of the detachable level and configured to supply electrical energy to charge the power source.

6. The power tool system according to claim 5, the detachable level further comprising a pendulum unit on which the leveling device is arranged, the pendulum unit being pivotably arranged in the housing in such a way that the at least one laser line emitted by the at least one laser line generator is level.

7. The power tool system according to claim 6, wherein:
the battery of the power tool is operably connected to a plurality of receptacle electrical contacts arranged in the receptacle,
the housing of the detachable level including a plurality of electrical contacts corresponding to the plurality of receptacle contacts, and
when the detachable level is received in the receptacle, the power source of the detachable level receives electrical power from the battery via the plurality of receptacle electrical contacts and the plurality of electrical contacts.

8. The power tool system according to claim 7, wherein the detachable level further comprises a wireless charging arrangement configured to transmit electrical power wirelessly from the housing to the pendulum unit so as to charge the power source.

9. The power tool system according to claim 8, wherein the wireless charging arrangement includes a first inductive loop in the housing that is operably connected to the plurality of electrical contacts and a second inductive loop arranged on the pendulum unit that is operably connected to the power source.

10. The power tool system according to claim 6, wherein the receptacle includes a locking arrangement having at least one locking member that engages with the pendulum unit and disables movement of the pendulum unit relative to the housing when the detachable level is received in the receptacle.

11. The power tool system according to claim 5, wherein:
the detachable level further comprises at least one bubble or spirit level, and
the laser device is fixedly connected to and supported by the housing.

12. The power tool system according to claim 3, wherein the detachable level further comprises a switch configured to automatically activate the at least one laser generator when the detachable level is removed from the receptacle and automatically deactivate the at least one laser generator when the detachable level is inserted into the receptacle.

13. The power tool system according to claim 12, wherein the switch is configured as a magnetic reed switch that interacts with a corresponding magnet arranged in or adjacent to the receptacle so as to detect whether the detachable level is received in the receptacle.

14. A power tool system comprising:
a power tool having a receptacle; and
a detachable level configured to be detachably received in the receptacle, the detachable level including a self-leveling laser line generator configured to generate at least one level laser line, the detachable level further comprising at least one power source that is operably connected to the laser line generator and is configured to receive electrical energy from the power tool.

15. The power tool system according to claim 14, wherein the detachable level further comprises a switch configured to automatically activate the at least one laser generator when the detachable level is removed from the receptacle and automatically deactivate the at least one laser line generator when the detachable level is inserted into the receptacle.

16. The power tool system according to claim 15, the detachable level further comprising a pendulum unit on which the laser line generator, the at least one power source, and the switch are arranged, the pendulum unit being pivotably arranged in the housing in such a way that the laser line generator is self-leveling.

17. The power tool system according to claim 16, wherein the detachable level further comprises a wireless charging arrangement configured to transmit electrical power wirelessly from the housing to the pendulum unit so as to charge the power source.

18. The power tool system according to claim 17, wherein the wireless charging arrangement includes a first inductive loop in the housing that is operably connected to the plurality of electrical contacts and a second inductive loop arranged on the pendulum unit that is operably connected to the power source.

19. The power tool system according to claim 15, wherein:
the detachable level further comprises at least one bubble or spirit level, and
the laser device is fixedly connected to and supported by the housing.

20. A laser level configured to be detachable received in a receptacle of a power tool, the laser level comprising:
a housing defining at least one window;
at least one laser line generator configured to emit at least one laser line through the at least one window of the housing;
a power source configured to supply electrical power to the at least one laser line generator;
a switch configured to automatically activate the at least one laser generator when the detachable level is removed from the receptacle and automatically deactivate the at least one laser generator when the detachable level is inserted into the receptacle; and
a pendulum unit on which the at least one laser line generator, the power source, and the housing are arranged, the pendulum unit being pivotably arranged in the housing in such a way that the at least one laser line generator is self-leveling.
